(19) United States
(12) Patent Application Publication
(10) Pub. No.: US 2024/0225113 A1
(43) Pub. Date: Jul. 11, 2024

(54) AEROSOL GENERATING DEVICE

(71) Applicant: KT &G CORPORATION, Daejeon (KR)

(72) Inventors: Dong Sung KIM, Seoul (KR); Young Bum KWON, Gyeonggi-do (KR); Yong Hwan KIM, Gyeonggi-do (KR); Hun II LIM, Seoul (KR); Seok Su JANG, Daejeon (KR)

(73) Assignee: KT &G CORPORATION, Daejeon (KR)

(21) Appl. No.: 18/563,136

(22) PCT Filed: Nov. 10, 2022
(86) PCT No.: PCT/KR2022/017669

§ 371 Date: Nov. 21, 2023

(30) Foreign Application Priority Data
Nov. 11, 2021 (KR) 10-2021-0155184
May 24, 2022 (KR) 10-2022-0063588

(51) Int. Cl. A24F 40/48; A24F 40/465; A24F 40/51; H05B 6/10

(52) U.S. Cl. CPC A24F 40/48; A24F 40/465; A24F 40/51; H05B 6/108

(57) ABSTRACT

An aerosol generating device includes an inner cylinder including an accommodation space for accommodating an aerosol generating article, a first support portion arranged at an entrance of the accommodation space to support the aerosol generating article accommodated in the accommodation space, the first support portion including an inlet passage through which external air is introduced into the accommodating space, a second support portion inside the accommodation space to support an end of the aerosol generating article, the second support portion including a transfer passage through which air in the accommodation space flows into the aerosol generating article, and a heater arranged inside the accommodation space to support an outer surface of the aerosol generating article and configured to generate heat to heat the aerosol generating article.

### TECHNICAL FIELD

Embodiments relate to an aerosol generating device, and more particularly, to an aerosol generating device that may smoothly supply air to an aerosol generating article.

### BACKGROUND ART

Recently, there has been an increased demand for a technology to replace a method of supplying an aerosol by burning a general cigarette. For example, research has been conducted on a method in which an aerosol is generated from an aerosol generating material in a liquid or solid state or a flavored aerosol is supplied by generating a vapor from an aerosol generating material in a liquid state and passing the generated vapor through a solid fragrance medium.

Recently, an aerosol generating device that may generate an aerosol by heating an aerosol generating article has been proposed to replace a method of supplying an aerosol by burning a cigarette. For example, the aerosol generating device may refer to a device that may generate an aerosol by heating an aerosol generating material in a liquid or solid state at a preset temperature through a beater.

When the aerosol generating device is used, it is possible to smoke without an ad-ditional accessory such as a lighter, and a user's smoking convenience may be improved by allowing a user to smoke as much as he/she wants. Thus, research on aerosol generating devices has increased in recent years.

### DISCLOSURE OF INVENTION

### Technical Problem

In order to improve the atomization performance of an aerosol generating device, air has to be smoothly supplied to an aerosol generating article.

Various embodiments of the present disclosure provide an aerosol generating device with improved atomization performance due to smoothly supplying air to an aerosol generating article.

The technical problems of the present disclosure are not limited to the above-described description, and other technical problems may be clearly understood by one of ordinary skill in the art from the embodiments to be described hereinafter.

### Solution to Problem

An aerosol generating device according to an embodiment includes an inner cylinder including an accommodation space for accommodating an aerosol generating article, a first support portion arranged at an entrance of the accommodation space to support the aerosol generating article accommodated in the accommodation space, the first support portion including an inlet passage through which external air is introduced into the accommodating space, a second support portion arranged inside the accommodation space to support an end of the aerosol generating article, the second support portion including a transfer passage through which air in the accommodation space flows into the aerosol generating article, and a heater arranged inside the accommodation space to support an outer surface of the aerosol generating article and configured to generate heat to heat the aerosol generating article.

### Advantageous Effects of Invention

Aerosol generating devices according to various embodiments of the present disclosure may improve atomization performance by effectively introducing an airflow into aerosol generating articles.

In addition, the aerosol generating devices according to various embodiments of the present disclosure may obtain a sufficient amount of air to be introduced into the inside thereof, and thus, the atomization amount of an aerosol generating article may be improved.

Effects of the present disclosure are not limited to the above effects, and effects that are not mentioned could be clearly understood by one of ordinary skill in the art from the present specification and the attached drawings.

### BRIEF DESCRIPTION OF DRAWINGS

FIG. 1 is a perspective view of an aerosol generating device according to an embodiment;

FIG. 2 is a cross-sectional view of a part of the aerosol generating device illustrated in FIG. 1;

FIG. 3 is a cross-sectional view of a part of the aerosol generating device illustrated in FIG. 1, which is taken at a different angle from FIG. 2;

FIG. 4 is an exploded perspective view of a part of the aerosol generating device illustrated in FIG. 1;

FIG. 5 is an exploded perspective view illustrating an enlarged part of FIG. 4;

FIG. 6 is an enlarged cross-sectional view of some components of the aerosol generating device illustrated in FIG. 1;

FIG. 7 is a perspective view of a first support portion mounted in the aerosol generating device illustrated in FIG. 1;

FIG. 8 is a perspective view of a second support portion mounted in the aerosol generating device illustrated in FIG. 1;

FIG. 9 is a perspective view of an inner cylinder of an aerosol generating device according to another embodiment; and

FIG. 10 is a block diagram of an aerosol generating device according to another embodiment.

### MODE FOR THE INVENTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be ar-bitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, when an expression such as “at least anyone” precedes arranged elements, it modifies all elements rather than each arranged element. For example, the expression “at least any one of a, b, and c” should be construed to include a, b, c, or a and b, a and c, b and c, or a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. Also, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the present disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and generated aerosols may be delivered to a user through a cigarette. That is, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. At this time, the ultrasonic vibration method may mean a method of generating aerosols by converting an aerosol generating material into aerosols with ultrasonic vibration generated by a vibrator.

The aerosol generating device may include a vibrator, and generate a short-period vibration through the vibrator to convert an aerosol generating material into aerosols. The vibration generated by the vibrator may be ultrasonic vibration, and the frequency band of the ultrasonic vibration may be in a frequency band of about 100 kHz to about 3.5 MHz, but is not limited thereto.

The aerosol generating device may further include a wick that absorbs an aerosol generating material. For example, the wick may be arranged to surround at least one area of the vibrator, or may be arranged to contact at least one area of the vibrator.

As a voltage (for example, an alternating voltage) is applied to the vibrator, heat and/or ultrasonic vibrations may be generated from the vibrator, and the heat and/or ultrasonic vibrations generated from the vibrator may be transmitted to the aerosol generating material absorbed in the wick. The aerosol generating material absorbed in the wick may be converted into a gaseous phase by heat and/or ultrasonic vibrations transmitted from the vibrator, and as a result, aerosols may be generated.

For example, the viscosity of the aerosol generating material absorbed in the wick may be lowered by the heat generated by the vibrator, and as the aerosol generating material having a lowered viscosity is granulated by the ultrasonic vibrations generated from the vibrator, aerosols may be generated, but is not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the suspector may be a magnetic body that generates heat by an external magnetic field. As the suspector is positioned inside the coil and a magnetic field is applied to the suspector, the suspector generates heat to heat an aerosol generating article. In addition, optionally, the suspector may be positioned within the aerosol generating article.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the present disclosure will now be described more fully with reference to the accompanying drawings, in which exemplary embodiments of the present disclosure are shown such that one of ordinary skill in the art may easily work the present disclosure. The present disclosure may be implemented in a form that can be implemented in the aerosol generating devices of the various embodiments described above or may be implemented in various different forms, and is not limited to the embodiments described herein.

Hereinafter, embodiments of the present disclosure will be described in detail with reference to the drawings.

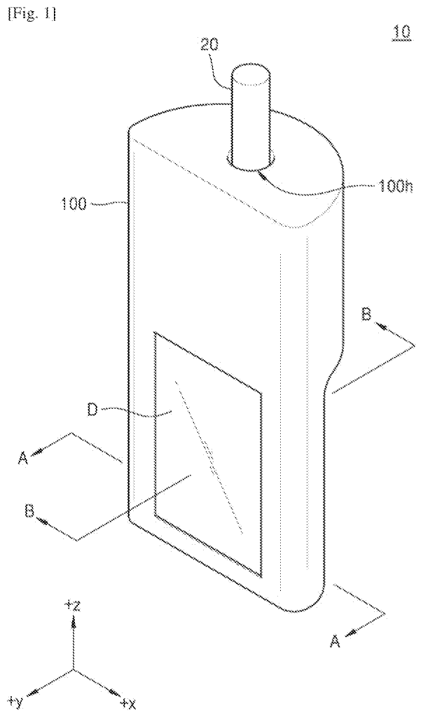

FIG. 1 is a perspective view of an aerosol generating device according to an embodiment.

Referring to FIG. 1, an aerosol generating device 10 according to an embodiment may include a housing 100 into which an aerosol generating article 20 may be inserted.

The housing 100 may form the entire appearance of the aerosol generating device 10 and include an inner space (or an ‘arrangement space’) in which components of the aerosol generating device 10 may be arranged. Although the housing 100 having a semicircular cross-section is illustrated in the figure, the shape of the housing 100 is not limited thereto. For example, the housing 100 may also be formed in a cylindrical shape or a polygonal column (for example, a triangular column or a quadrangular column) shape as a whole.

Components for generating an aerosol by heating an aerosol generating article 20 that is inserted into the housing 100 and components for detecting a user's puff action may be arranged in the inner space of the housing 100, and details thereof will be described below.

According to one embodiment, the housing 100 may include an opening 100h through which the aerosol generating article 20 may be inserted into the housing 100. At least a part of the aerosol generating article 20 may be inserted into or accommodated in the housing 100 through the opening 100h.

the aerosol generating article 20 that is inserted into or accommodated in the housing 100 may be heated in the housing 100 to generate an aerosol. A user may inhale an aerosol discharged from the aerosol generating article 20.

The aerosol generating device 10 may further include a display D on which visual information is displayed.

The display D may be arranged to expose at least a partial region of *?* the display D in the outside of the housing 100. The aerosol generating device 10 may provide a various types of visual information to a user through the display D.

For example, the aerosol generating device 10 may provide information on whether there is occurrence of a user's puff action and/or information on the remaining number of puffs of the inserted aerosol generating article 20 on the display D, but the information provided on the display D may be modified in various types.

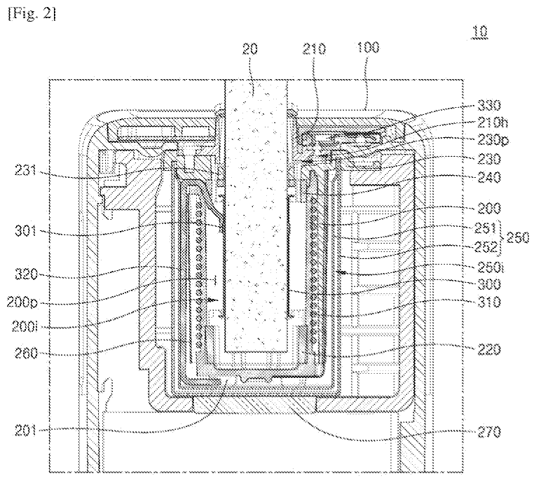

FIG. 2 is a cross-sectional view of a part of the aerosol generating device illustrated in FIG. 1.

FIG. 2 is a cross-sectional view taken along an A-A direction of the aerosol generating device 10 illustrated in FIG. 1.

The aerosol generating device 10 according to an embodiment may include an inner cylinder 200, a first support portion 210, a second support portion 220, and a heater 300.

The inner cylinder 200 may be in an inner space of the housing 100. The inner cylinder 200 may include an accommodation space 200i for accommodating the aerosol generating article 20.

The accommodation space 200i not only accommodates the aerosol generating article 20 but also may serve as a passage through which air introduced from the outside flows. An inner passage 200p may be formed between the inner cylinder 200 and the heater 300 such that air introduced into the accommodation space 200i through an inlet passage of the first support portion 210 flows to the second support portion 220. The air introduced into the accommodation space 200i may move along the inner passage 200p to reach the second support portion 220.

The first support portion 210 may be at an entrance of the accommodation space 200i to support at least a part of the aerosol generating article 20 accommodated in the accommodation space 200i. In addition, the first support portion 210 may allow air outside the aerosol generating device 10 to be introduced into the accommodation space 200i.

The first support portion 210 may include a support body for supporting at least a part of an aerosol generating article and an inlet passage through which air outside the aerosol generating device 10 is introduced into the accommodation space 200i.

The first support portion 210 may include a puff sensing hole 210h that is connected to a puff sensor 330. The puff sensing hole 210h may be at a lower end of the puff sensor 330 adjacent to the first support portion 210. The air passing through the inlet passage may be introduced into the puff sensor 330 through the puff sensing hole 210h. The puff sensing hole 210h may be narrowed toward the puff sensor 330 but is not limited to the shape described above.

The second support portion 220 may be inside the accommodation space 200i to support an end of the aerosol generating article 20. In addition, the second support portion 220 may allow air in the accommodation space 200i to flow into the aerosol generating article 20.

The second support portion 220 may include a transfer passage through which air in the accommodation space 200i flows into an aerosol generating article.

One end (for example, a lower end) of the heater 300 may be inserted into the second support portion 220. Accordingly, the heater 300 may be supported by the second support portion 220.

A coupling portion 230 may be coupled to a lower end of the first support portion 210.

The coupling portion 230 may include a first air hole through which air passing through an inlet passage of the first support portion 210 flows into the accommodation space 200i.

When the coupling portion 230 is coupled to the first support portion 210, the puff detection passage 230p may be formed between an upper end of the coupling portion 230 and the first support portion 210. The puff detection passage 230p may connect the inlet passage to the puff sensor 330. Air passing through the inlet passage of the first support portion 210 may pass through the puff detection passage 230p to be introduced into the puff sensor 330 adjacent to the first support portion 210.

According to one embodiment, air moving along the puff detection passage 230p may pass through the puff sensing hole 210h of the first support portion 210 to reach the puff sensor 330.

A part of the coupling portion 230 may wrap around an outer circumference of the inner cylinder 200. Other components on the outside of the coupling portion 230 may be supported by the coupling portion 230 in contact with a part of the coupling portion 230 described above.

Another part of the coupling portion 230 may be open. Accordingly, the aerosol generating device 10 may have a space in which other components may be inside the aerosol generating device 10.

The coupling portion 230 may further include a guide 231 for guiding an insertion operation of the aerosol generating article 20.

In order to prevent insertion of the aerosol generating article 20 from being ob-structed due to being caught in the guide 231 while the aerosol generating article 20 is inserted into the aerosol generating device 10, at least a part of the guide 231 (for example, an upper end) may be chamfered. The chamfered portion may be beveled or rounded.

In another example, the guide 231 may support at least a part of an outer circumferential surface of the aerosol generating article 20.

One end (for example, an upper end) of the inner cylinder 200 may be inserted into the coupling portion 230. Due to this, the inner cylinder 200 may be supported by the coupling portion 230.

One end (for example, an upper end) of an outer cylinder 250 may be inserted into the coupling portion 230. Due to this, the outer cylinder 250 may be supported by the coupling portion 230.

An upper ring 240 may be coupled to a lower surface of an upper portion of the coupling portion 230.

The upper ring 240 may include a second air bole through which air moving through a first air hole of the coupling portion 230 is introduced into the accommodation space 200i.

One end (for example, an upper end) of the beater 300 may be inserted into the upper ring 240. Accordingly, the heater 300 may be supported by the upper ring 240.

The outer cylinder 250 may be separated from the inner cylinder 200 toward the outside of the inner cylinder 200.

The outer cylinder 250 may block the heat generated by the heater 300 from being transferred to the outside. In order to increase efficiency of insulation, the outer cylinder 250 may have a structure of double walls.

The outer cylinder 250 may include an inner wall 251 facing the inner cylinder 200, an outer wall 252 separated from the inner wall 251 toward the outside of the outer cylinder 250, and a heat insulation space 250i formed between the inner wall 251 and the outer wall 252. The heat insulation space 250i may be in a vacuum state to prevent heat from being transferred to the outside of the aerosol generating device 10. Here, the ‘vacuum state’ includes not only a state in which there is no air but also a state in which a pressure is lower than the ambient atmospheric pressure.

The outer cylinder 250 may include a through-hole at a lower end thereof. One or more wires or a magnetic field generators 310 may exit to the outside of the outer cylinder 250 through the through-hole of the outer cylinder 250.

The inner cylinder 200 may include at least one support base 201 in contact with an inner lower end of the outer cylinder 250. The inner cylinder 200 may be separated from the outer cylinder 250 toward the inside of the outer cylinder 250 by the support base 201 and may be supported by the outer cylinder 250 in a longitudinal direction in which the aerosol generating article 20 is inserted.

A shield portion 260 may be arranged to surround an outer circumferential surface of at least a part of the coupling portion 230. The shield portion 260 may be in contact with an outer circumferential surface of at least a part of the coupling portion 230 to be supported by the coupling portion 230.

The shield portion 260 may block an induction magnetic field generated inside the aerosol generating device 10 from leaking to the outside of the aerosol generating device 10.

The shield portion 260 may include a wiring holeopened in a radius direction of the accommodation space 200i such that a temperature sensing wire 320 may pass therethrough.

A sealing portion 270 may be arranged at an outer lower end of the outer cylinder 250 to prevent liquid from leaking. The sealing portion 270 may include, for example, an elastic material such as rubber or silicone.

The sealing portion 270 may include a wiring passage through which one or more wires or the magnetic field generators 310 passes. The one or more wires or magnetic field generators 310 may exit to the outside of the sealing portion 270 through the wiring passage of the sealing portion 270.

The heater 300 may be arranged inside the accommodation space 200i. The heater 300 may accommodate at least a part of the aerosol generating article 20 inserted into the housing 100. The heater 300 may support an outer circumferential surface of the aerosol generating article 20 accommodated in the accommodation space 200i.

The heater 300 may generate heat as power is supplied thereto. At least one region of the accommodated aerosol generating article 20 may be heated by the beater 300. Vaporized particles generated from the aerosol generating article 20 when the aerosol generating article 20 is heated may be mixed with air in an inner space of the housing 100 to generate an aerosol.

The aerosol generating device 10 according to an embodiment may include the magnetic field generators 310. In this case, the heater 300 may serve as a susceptor.

The magnetic field generators 310 may be coupled to the inner cylinder 200. For example, the magnetic field generators 310 may be mounted on the outside of the inner cylinder 200.

The magnetic field generators 310 may heat at least one region of the aerosol generating article 20 accommodated in the accommodation space 200i by using an induction heating method.

The magnetic field generators 310 may be arranged to surround an outer circumferential surface of the susceptor 300 and may generate an induction magnetic field toward the susceptor 300 according to power supplied from a battery.

The susceptor 300 may be arranged to surround at least a part of an outer circumferential surface of the aerosol generating article 20 accommodated in the accommodation space 200i. The susceptor 300 may heat the aerosol generating article accommodated in the accommodation space 200i by being heated by an alternating magnetic field generated by the magnetic field generators 310.

In another example of the heater 300, the aerosol generating device 10 may include an electrically resistive heater. For example, the aerosol generating device may include a film heater arranged to surround at least a part of an outer circumferential surface of an aerosol generating article inserted into the housing 100. The film heater may include an electrically conductive track, and when an electric current flows through the electrically conductive track, the film heater may generate heat to heat the aerosol generating article inserted into the housing 100.

In another example of the heater 300, the aerosol generating device 10 may include at least one of a needle-type heater, a rod-type heater, and a tubular heater that may heat the inside of the aerosol generating article inserted into the housing 100. The heater described above may be inserted into, for example, at least one region of the aerosol generating article to heat the inside of the aerosol generating article.

Examples are not limited by a specific implementation manner of the heater 300, and the heater may be modified in various forms to heat the aerosol generating article 20 to a designated temperature. In the present disclosure, the ‘designated temperature’ may indicate a temperature at which an aerosol generating material included in the aerosol generating article 20 may be heated to generate an aerosol. The designated temperature may be a temperature preset in the aerosol generating device 10. Alternatively, the designated temperature may be changed by the type of the aerosol generating device 10 and/or a user's operation.

The temperature sensing wire 320 is an example of a temperature sensor. The temperature sensing wire may be a thermocouple. In another example, the temperature sensing wire is a thermally conductive wire for transferring heat, and a sensor module for generating a signal according to a temperature change may be connected to the temperature sensing wire.

A part of the temperature sensing wire 320 may be connected to the heater 300. The temperature sensing wire 320 may detect a temperature change of the heater 300 while the heater 300 operates.

The temperature sensing wire 320 may exit from the accommodation space 200i to the outside of the inner cylinder 200 through a space between the inner cylinder 200 and the coupling portion 230. The temperature sensing wire 320 may extend through a space between the inner cylinder 200 and the outer cylinder 250.

The other portion of the temperature sensing wire 320 may exit to the outside of the outer cylinder 250 through a through-hole of the outer cylinder 250 and the outer cylinder 250.

The heater 300 may further include a protrusion 301 protruding outward. A part of the temperature sensing wire 320 described above may be connected to a protrusion 301 of the heater 300.

The puff sensor 330 may detect a pressure change in an airflow passage according to a user's puff action. The puff sensor 330 may be arranged adjacent to the first support portion 210.

Positions and shapes of the components described above are not limited to the embodiments and may be variously modified.

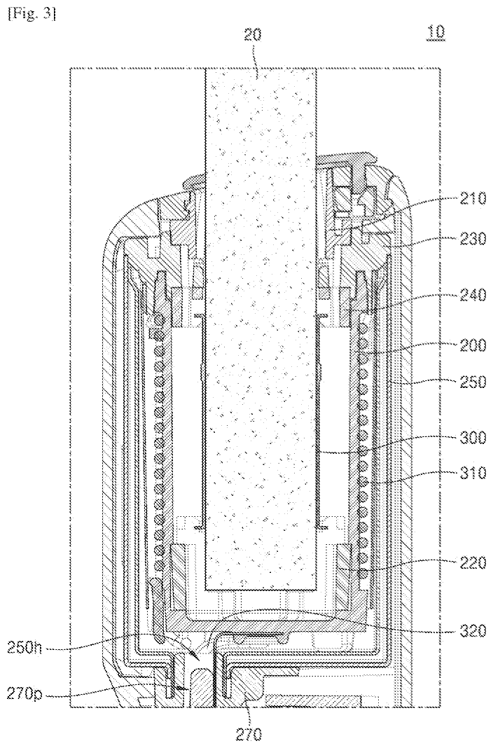

FIG. 3 is a cross-sectional view of a part of the aerosol generating device illustrated in FIG. 1 which is taken at a different angle from FIG. 2.

FIG. 3 is a cross-sectional view taken in a B-B direction of the aerosol generating device 10 illustrated in FIG. 1.

Descriptions overlapping the descriptions made with reference to FIG. 2 are omitted below.

Referring to FIG. 3, a through-hole 250h of the outer cylinder 250 and a wiring passage 270p of the sealing portion 270 may be at a location separated from a central axis of the aerosol generating article 20 in a longitudinal direction.

At least a part of the sealing portion 270 may be inserted into the through-hole 250h of the outer cylinder 250. One or more electric wires or the magnetic field generators 310 may pass through the through-hole 250h of the outer cylinder 250 and pass through the wiring passage 270p of the sealing portion 270 at the same time.

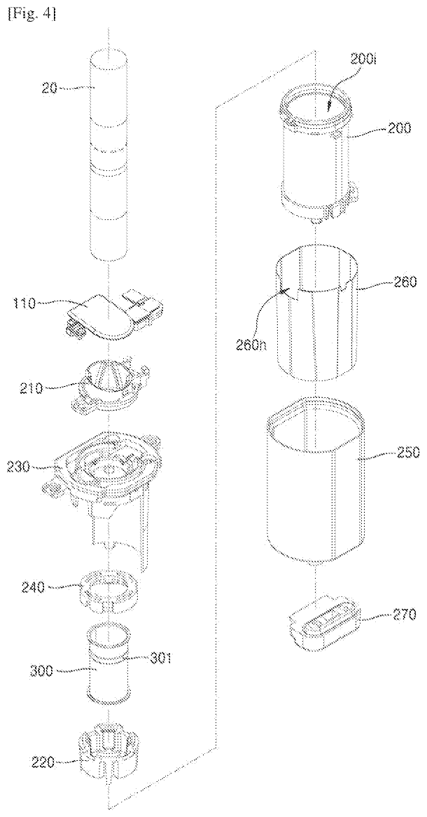

FIG. 4 is an exploded perspective view of a part of the aerosol generating device illustrated in FIG. 1.

A dashed-dotted line illustrated in FIG. 4 represents a central axis of the aerosol generating article 20 in a longitudinal direction which is inserted into the aerosol generating device.

FIG. 4 is a view illustrating relative positions of respective components of the aerosol generating device along the dashed-dotted line.

The aerosol generating device according to an embodiment may include a cover 110.

The cover 110 may be arranged on an upper end of the housing (100 in FIG. 1) to open and close an opening (100h in FIG. 1) of a housing (100 in FIG. 1). A user may push the cover 110 to open the opening (100H in FIG. 1) and insert the aerosol generating article 20 into the aerosol generating device through the opening (100H in FIG. 1).

The aerosol generating article 20 inserted into the aerosol generating device may come into contact with the first support portion 210, the coupling portion 230, the upper ring 240, the heater 300, and the second support portion 220 sequentially in a longitudinal direction in which the aerosol generating article 20 is inserted.

The heater 300 and the second support portion 220 may be arranged in the accommodation space 200i of the inner cylinder 200, and the coupling portion 230 and the upper ring 240 may be arranged at an entrance of the inner cylinder 200.

The coupling portion 230 may be arranged at the entrance of the inner cylinder 200 to wrap at least a part of an outer circumferential surface of the inner cylinder 200 while supporting an upper end of the inner cylinder 200.

The protrusion 301 of the heater 300 may protrude from an outer circumferential surface of the heater 300 to the outside of the beater 300 to extend in a circumferential direction of the heater 300. A part of a temperature sensing wiring (320 in FIG. 2) may be connected to the protrusion 301 of the heater 300.

The shield portion 260 may surround an outer circumferential surface of the coupling portion 230 from the outside of the coupling portion 230. The shield portion 260 may include a wiring bole 260h opened in a radius direction of the accommodation space 200i such that the temperature sensing wiring 320 (in FIG. 2) may pass therethrough. A position of the wiring hole 260h may change depending on embodiments.

The shield portion 260 may be arranged inside the outer cylinder 250, and the sealing portion 270 may be arranged at an outer lower end of the outer cylinder 250.

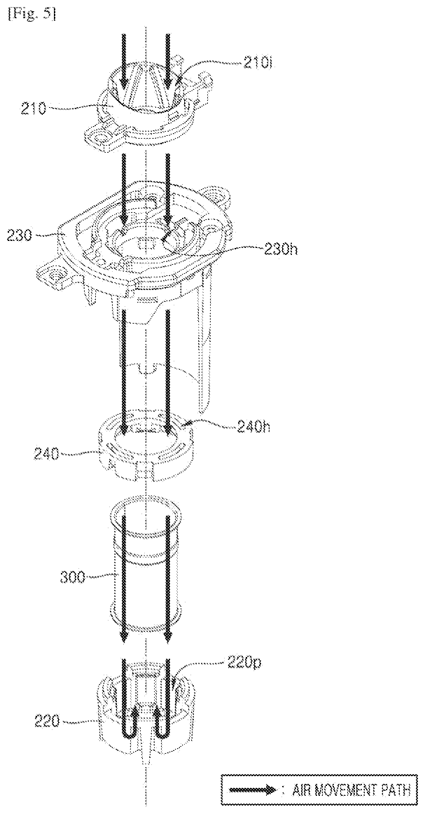

FIG. 5 is an exploded perspective view illustrating an enlarged part of FIG. 4.

FIG. 5 is an exploded perspective view illustrating only relevant components in an enlarged manner to illustrate a flow of air.

When an inlet passage 210i of the first support portion 210, a first air hole 230h of the coupling portion 230, a second air hole 240h of the upper ring 240, an inner passage between the inner cylinder 200 and the heater 300, and a transfer passage 220p of the second support portion 220 are connected to each other, an airflow passage may be formed. Here, the ‘airflow path’ may mean a path through which air moves from the outside of the aerosol generating device to a lower end of the aerosol generating article.

The first support portion 210, the coupling portion 230, the upper ring 240, the heater 300, and the second support portion 220 may be arranged to be connected in a longitudinal direction in which the aerosol generating article is inserted.

The inlet passage 210i of the first support portion 210, the first air hole 230h of the coupling portion 230, the second air hole 240h of the upper ring 240, and the transfer passage 220p of the second support portion 220 may be connected to each other in the longitudinal direction described above. Due to this, the air introduced through the inlet passage 210i may flow in the longitudinal direction described above. Here, the components ‘connected in a longitudinal direction’ not only mean that centers of holes of the components are aligned to completely coincide with each other but also include an arrangement structure in which the holes of the respective components are connected to each other such that air may flow in the longitudinal direction.

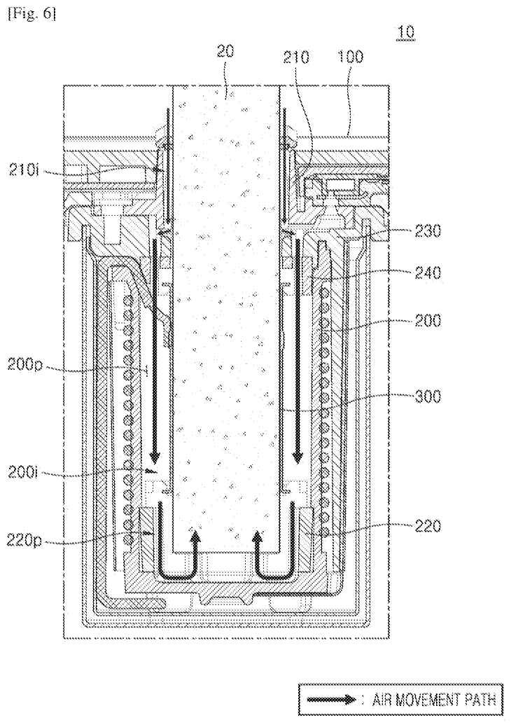

FIG. 6 is an enlarged cross-sectional view of some components of the aerosol generating device illustrated in FIG. 1.

FIG. 6 is a view illustrating an air movement process according to a user's puff action in the aerosol generating device.

According to one embodiment, when the mouth of a user comes into contact with the aerosol generating article 20 and a user's puff action is performed, a pressure difference occurs between the outside of the aerosol generating device 10 and an inner space of the housing 100, and thus, external air may be introduced into the housing 100 through the first support portion 210.

The external air introduced into the housing 100 may pass through the inlet passage 210i of the first support portion 210. The air passing through the inlet passage 210i passes through the first air hole 230h and the second air hole 240h to reach the inner passage 200p between the inner cylinder 200 and the heater 300. The air moving along the inner passage 200p may be introduced into the second support portion 220.

The air introduced into the transfer passage 220p of the second support portion 220 may pass through the transfer passage 220p while drawing a U-shape along a shape of the second support portion 220, and then may enter an end of the aerosol generating article 20 inserted into the accommodation space 200i.

The air introduced into the aerosol generating article 20 may be mixed with vaporized particles generated as the aerosol generating article 20 is heated, thereby generating an aerosol. A user may inhale the aerosol generated in the accommodation space 200i through a puff action of inhaling the aerosol generating article 20.

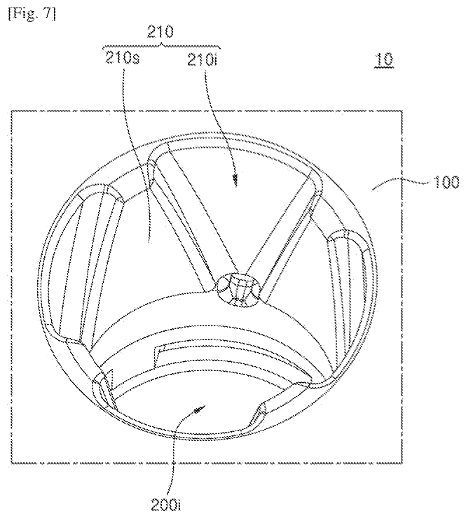

FIG. 7 is a perspective view of a first support mounted in the aerosol generating device illustrated in FIG. 1.

The first support portion 210 may include one or more support bodies 210s for supporting at least a part of the aerosol generating article, and an inlet passage 210i through which external air of the aerosol generating device 10 is introduced into the accommodation space 200i.

The support bodies 210s may support the aerosol generating article by being in contact with at least a part of the outside of an aerosol generating article. Accordingly, a plurality of support bodies 210s may be arranged in a circumferential direction of the accommodation space 200i to be in contact with the outside of an aerosol generating article. When an aerosol generating article is inserted into the first support portion 210, the support bodies 210s may come into contact with the aerosol generating article and form the inlet passage 210i at the same time in a space between the first support portion 210 and the aerosol generating article. That is, the inlet passage 210i may be between adjacent support bodies 210s.

The inlet passage 210i allows air to flow and may have s shape which is narrowed from the outside of the aerosol generating device 10 to the inside of the accommodation space 200i. The shape of the inlet passage 210i may provide two advantages in relation to an air flow compared to a case in which a shape of the inlet passage has a constant width in the longitudinal direction of the housing 100.

First, an area of an opening of the inlet passage 210i opened toward the outside of the housing 100 is the widest among all paths of the inlet passage 210i, and thus, a sufficient amount of external air may be smoothly introduced into the accommodation space 200i. Atomization performance of the aerosol generating device 10 may be improved due to the structure of the inlet passage 210i.

Second, a size of the inlet passage 210i may be gradually reduced from an opening opened to the outside of the housing 100 to the inside of the accommodation space 200i. Due to a change in size of the inlet passage 210i, a flow velocity of an airflow passing through the inlet passage 210i may change. As the flow velocity of the airflow changes, an air pressure in the accommodation space 200i may change, and a puff sensor (330 in FIG. 2) may detect a pressure change of air. A controller may recognize occurrence of a puff action in which a user performs an inhale action, based on detection of a pressure change by the puff sensor (330 of FIG. 2).

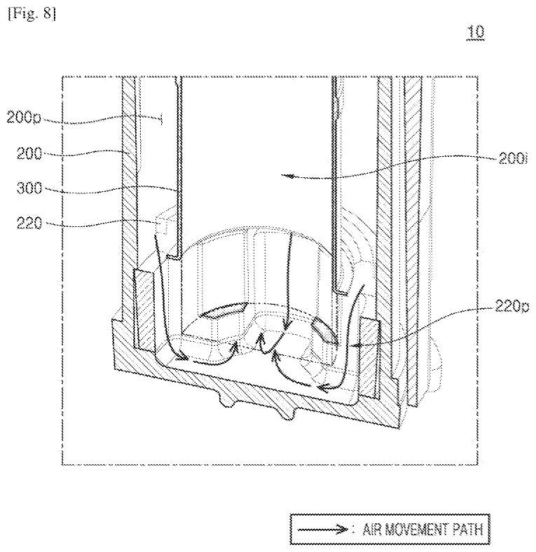

FIG. 8 is a perspective view of a second support portion mounted in the aerosol generating device illustrated in FIG. 1.

FIG. 8 is a view illustrating a process of moving air in the second support portion 220.

When an aerosol generating article is inserted into the aerosol generating device 10 and comes into contact with an inner surface of the second support portion 220, the transfer passage 220p may be formed between the second support portion 220 and the aerosol generating article.

Air moving along the inner passage 200p between the inner cylinder 200 and the heater 300 may be introduced into the transfer passage 220p of the second support portion 220. The transfer passage 220p may have a U shape along a shape of the second support portion 220. Air moving along the transfer passage 220p may reach an end of the aerosol generating article.

However, an arrangement and a shape of the transfer passage 220p are not limited to the embodiments described above and may be changed in various forms.

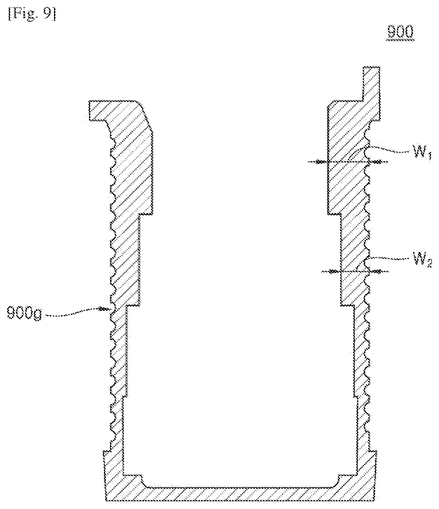

FIG. 9 is a perspective view of an inner cylinder of an aerosol generating device according to another embodiment.

Compared to the inner cylinder 200 of the aerosol generating device according to one embodiment, an inner cylinder 900 of an aerosol generating device according to another embodiment has a groove 900g formed on the outside of the inner cylinder 900. A magnetic field generator may be mounted in the groove 900g. The mounted magnetic field generator may be more strongly coupled to the inner cylinder 900.

Compared to the inner cylinder 200 of the aerosol generating device according to one embodiment, the inner cylinder 900 of the aerosol generating device according to another embodiment may include the inner cylinder 900 having at least a part of which thickness is reduced to obtain a sufficient flow amount of air accommodated in an accommodation space. For example, a thickness of the inner cylinder 900 may be reduced (W1>W2) toward a bottom surface of a lower end of the inner cylinder 900 in a longitudinal direction in which an aerosol generating article is inserted. Accordingly, a size of an accommodating space increases toward the bottom surface of the lower end of the inner cylinder 900, and thus, more flow amount of air may be obtained.

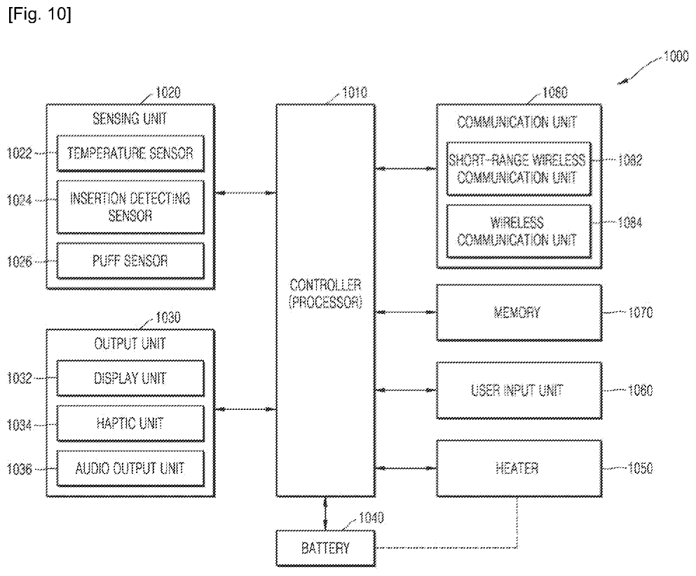

FIG. 10 is a block diagram of an aerosol generating device according to an embodiment.

An aerosol generating device 1000 may include a controller 1010, a sensing unit 1020, an output unit 1030, a battery 1040, a heater 1050, a user input unit 1060, a memory 1070, and a communication unit 1080. However, the internal structure of the aerosol generating device 1000 is not limited to those illustrated in FIG. 10. That is, according to the design of the aerosol generating device 1000, it will be understood by one of ordinary skill in the art that some of the components shown in FIG. 10 may be omitted or new components may be added.

The sensing unit 1020 may sense a state of the aerosol generating device 1000 and a state around the aerosol generating device 1000, and transmit sensed information to the controller 1010. Based on the sensed information, the controller 1010 may control the aerosol generating device 1000 to perform various functions, such as controlling an operation of the heater 1050, limiting smoking, determining whether an aerosol generating article (e.g., a cigarette, a cartridge, or the like) is inserted, displaying a no-tification, or the like.

The sensing unit 1020 may include at least one of a temperature sensor 1022, an insertion detection sensor 1024, and a puff sensor 1026, but is not limited thereto.

The temperature sensor 1022 may sense a temperature at which the heater 1050 (or an aerosol generating material) is heated. The aerosol generating device 1000 may include a separate temperature sensor for sensing the temperature of the heater 1050, or the heater 1050 may serve as a temperature sensor. Alternatively, the temperature sensor 1022 may also be arranged around the battery 1040 to monitor the temperature of the battery 1040.

The insertion detection sensor 1024 may sense insertion and/or removal of an aerosol generating article. For example, the insertion detection sensor 1024 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 1026 may sense a user's puff on the basis of various physical changes in an airflow passage or an airflow channel. For example, the puff sensor 1026 may sense a user's puff on the basis of any one of a temperature change, a flow change, a voltage change, and a pressure change.

The sensing unit 1020 may further include, in addition to the temperature sensor 1022, the insertion detection sensor 1024, and the puff sensor 1026 described above, at least one of a temperature/humidity sensor, a barometric pressure sensor, a magnetic sensor, an acceleration sensor, a gyroscope sensor, a location sensor (e.g., a global po-sitioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 1030 may output information on a state of the aerosol generating device 1000 and provide the information to a user. The output unit 1030 may include at least one of a display unit 1032, a haptic unit 1034, and a sound output unit 1036, but is not limited thereto. When the display unit 1032 and a touch pad form a layered structure to form a touch screen, the display unit 1032 may also be used as an input device in addition to an output device.

The display unit 1032 may visually provide information about the aerosol generating device 1000 to the user. For example, information about the aerosol generating device 1000 may mean various pieces of information, such as a charging/discharging state of the battery 1040 of the aerosol generating device 1000, a preheating state of the heater 1050, an insertion/removal state of an aerosol generating article, or a state in which the use of the aerosol generating device 1000 is restricted (e.g., sensing of an abnormal object), or the like, and the display unit 1032 may output the information to the outside. The display unit 1032 may be, for example, a liquid crystal display panel (LCD), an organic light-emitting diode (OLED) display panel, or the like. In addition, the display unit 1032 may be in the form of a light-emitting diode (LED) light-emitting device.

The haptic unit 1034 may tactilely provide information about the aerosol generating device 1000 to the user by converting an electrical signal into a mechanical stimulus or an electrical stimulus. For example, the haptic unit 1034 may include a motor, a piezo-electric element, or an electrical stimulation device.

The sound output unit 1036 may audibly provide information about the aerosol generating device 1000 to the user. For example, the sound output unit 1036 may convert an electrical signal into a sound signal and output the same to the outside.

The battery 1040 may supply power used to operate the aerosol generating device 1000. The battery 1040 may supply power such that the heater 1050 may be heated. In addition, the battery 1040 may supply power required for operations of other components (e.g., the sensing unit 1020, the output unit 1030, the user input unit 1060, the memory 1070, and the communication unit 1080) in the aerosol generating device 1000. The battery 1040 may be a rechargeable battery or a disposable battery. For example, the battery 1040 may be a lithium polymer (LiPoly) battery, but is not limited thereto.

The heater 1050 may receive power from the battery 1040 to heat an aerosol generating material. Although not illustrated in FIG. 10, the aerosol generating device 1000 may further include a power conversion circuit (e.g., a direct current (DC)/DC converter) that converts power of the battery 1040 and supplies the same to the heater 1050. In addition, when the aerosol generating device 1000 generates aerosols in an induction heating method, the aerosol generating device 1000 may further include a DC/alternating current (AC) converter that converts DC power of the battery 1040 into AC power.

The controller 1010, the sensing unit 1020, the output unit 1030, the user input unit 1060, the memory 1070, and the communication unit 1080 may each receive power from the battery 1040 to perform a function. Although not illustrated in FIG. 10, the aerosol generating device 1000 may further include a power conversion circuit that converts power of the battery 1040 to supply the power to respective components, for example, a low dropout (LDO) circuit, or a voltage regulator circuit.

In an embodiment, the heater 1050 may include any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 1050 may be implemented by a metal wire, a metal plate on which an electrically conductive track is arranged, a ceramic heating element, or the like, but is not limited thereto.

In another embodiment, the heater 1050 may be a heater of an induction heating type. For example, the heater 1050 may include a susceptor that heats an aerosol generating material by generating heat through a magnetic field applied by a coil.

The user input unit 1060 may receive information input from the user or may output information to the user. For example, the user input unit 1060 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 10, the aerosol generating device 1000 may further include a connection interface, such as a universal serial bus (USB) interface, and may be connected to other external devices through the connection interface, such as the USB interface, to transmit and receive information, or to charge the battery 1040.

The memory 1070 is a hardware component that stores various types of data processed in the aerosol generating device 1000, and may store data processed and data to be processed by the controller 1010. The memory 1070 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 1070 may store an operation time of the aerosol generating device 1000, the maximum number of puffs, the current number of puffs, at least one temperature profile, data on a user's smoking pattern, etc.

The communication unit 1080 may include at least one component for communication with another electronic device. For example, the communication unit 1080 may include a short-range wireless communication unit 1082 and a wireless communication unit 1084.

The short-range wireless communication unit 1082 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra wideband (UWB) communication unit, an Ant+ communication unit, or the like, but is not limited thereto.

The wireless communication unit 1084 may include a cellular network communication unit, an Internet communication unit, a computer network (e.g., local area network (LAN) or wide area network (WAN)) communication unit, or the like, but is not limited thereto. The wireless communication unit 1084 may also identify and au-thenticate the aerosol generating device 1000 within a communication network by using subscriber information (e.g., International Mobile Subscriber Identifier (IMSI)).

The controller 1010 may control the overall operation of the aerosol generating device 1000. In an embodiment, the controller 1010 may include at least one processor. The processor may be implemented as an array of a plurality of logic gates, or may be implemented as a combination of a general-purpose microprocessor and a memory in which a program executable by the microprocessor is stored. It will be understood by one of ordinary skill in the art that the processor may be implemented in other forms of hardware.

The controller 1010 may control the temperature of the heater 1050 by controlling supply of power of the battery 1040 to the heater 1050. For example, the controller 1010 may control power supply by controlling switching of a switching element between the battery 1040 and the heater 1050. In another embodiment, a direct heating circuit may also control power supply to the heater 1050 according to a control command of the controller 1010.

The controller 1010 may analyze a result sensed by the sensing unit 1020 and control subsequent processes to be performed. For example, the controller 1010 may control power supplied to the heater 1050 to start or end an operation of the heater 1050 on the basis of a result sensed by the sensing unit 1020. In another embodiment, the controller 1010 may control, based on a result sensed by the sensing unit 1020, an amount of power supplied to the heater 1050 and the time the power is supplied, such that the heater 1050 may be heated to a certain temperature or maintained at an appropriate temperature.

The controller 1010 may control the output unit 1030 on the basis of a result sensed by the sensing unit 1020. For example, when the number of puffs counted through the puff sensor 1026 reaches a preset number, the controller 1010 may notify the user that the aerosol generating device 1000 will soon be terminated through at least one of the display unit 1032, the haptic unit 1034, and the sound output unit 1036.

In an embodiment, the controller 1010 may control the time of power supply and/or amount of power supply to the heater 1050 according to a state of an aerosol generating article (e.g., the aerosol generating article 20 of FIG. 1) sensed by the sensing unit 1020. For example, when the aerosol generating article 20 is in an over-wet state, the controller 1010 may control the time of power supply to an induction coil (e.g., a magnetic field generator 310 of FIG. 2) to increase the pre-heating time of the aerosol generating article 20 compared to a general condition.

One embodiment may also be implemented in the form of a computer-readable recording medium including instructions executable by a computer, such as a program module executable by the computer. The computer-readable recording medium may be any available medium that may be accessed by a computer, and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. An aerosol generating device comprising:
an inner cylinder including an accommodation space for accommodating an aerosol generating article;
a first support portion arranged at an entrance of the accommodation space to support the aerosol generating article accommodated in the accommodation space, the first support portion including an inlet passage through which external air is introduced into the accommodating space;
a second support portion arranged inside the accommodation space to support an end of the aerosol generating article, the second support portion including a transfer passage through which air in the accommodation space flows into the aerosol generating article; and
a heater arranged inside the accommodation space to support an outer surface of the aerosol generating article and configured to generate heat to heat the aerosol generating article.

2. The aerosol generating device of claim 1, wherein an inner passage is formed between the inner cylinder and the heater such that air introduced into the accommodation space through the inlet passage of the first support portion flows to the second support portion.

3. The aerosol generating device of claim 1, further comprising:
a puff sensor adjacent to the first support portion,
wherein the first support portion further includes a puff sensing hole connected to the puff sensor.

4. The aerosol generating device of claim 1, further comprising:
a coupling portion coupled to the first support portion,
wherein the coupling portion includes a first air hole through which air passing through the inlet passage of the first support portion is introduced into the accommodation space.

5. The aerosol generating device of claim 4, further comprising:
a puff sensor adjacent to the first support portion,
wherein a puff sensing passage connecting the inlet passage to the puff sensor is formed by the coupling portion and the first support portion.

6. The aerosol generating device of claim 4, further comprising:
an upper ring coupled to the coupling portion,
wherein the upper ring includes a second air hole through which air moving through the first air hole of the coupling portion is introduced into the accommodation space, and one end of the heater is configured to be inserted into the upper ring such that the upper ring supports the heater.

7. The aerosol generating device of claim 6, wherein
the first support portion, the coupling portion, the upper ring, the heater, and the second support portion are configured to be connected to each other in a longitudinal direction in which the aerosol generating article is inserted, and
the first air hole, the second air hole, and the transfer passage are configured to be connected to each other in the longitudinal direction such that air introduced through the inlet passage flows in the longitudinal direction.

8. The aerosol generating device of claim 4, further comprising:
an outer cylinder separated from the inner cylinder toward an outside of the inner cylinder to block heat generated by the heater from being transferred to outside,
wherein the outer cylinder includes a through-hole through which one or more wires or magnetic field generators pass.

9. The aerosol generating device of claim 8, wherein the outer cylinder includes an inner wall facing the inner cylinder, an outer wall separated from the inner wall toward an outside of the outer cylinder, and a heat insulation space formed between the inner wall and the outer wall.

10. The aerosol generating device of claim 8, wherein
the inner cylinder is configured to be inserted into a part of the coupling portion to be supported by the coupling portion, and
the inner cylinder further includes one or more support bases in contact with an inner lower end of the outer cylinder to be supported by the outer cylinder in a longitudinal direction in which the aerosol generating article is inserted.

11. The aerosol generating device of claim 8, further comprising:
a sealing portion arranged on an outer lower end of the outer cylinder to prevent liquid from leaking,
wherein the sealing portion includes a wiring passage through which one or more wires or magnetic field generators pass.

12. The aerosol generating device of claim 8, further comprising:
a temperature sensing wire having a part connected to the heater and extending through a space between the inner cylinder and the outer cylinder,
wherein another portion of the temperature sensing wire passes through the through-hole of the outer cylinder.

13. The aerosol generating device of claim 1, further comprising:
a magnetic field generator coupled to the inner cylinder and configured to generate an induction magnetic field toward the heater,
wherein the heater includes a susceptor configured to generate heat in response to the induction magnetic field.

14. The aerosol generating device of claim 13, further comprising:
a groove formed in an outside surface of the inner cylinder,
wherein the magnetic field generator is mounted in the groove in the inner cylinder.

15. The aerosol generating device of claim 1, wherein a thickness of at least a part of the inner cylinder decreases to obtain a sufficient flow amount of air to be accommodated in the accommodation space.
